(19) United States
(12) Patent Application Publication
(10) Pub. No.: US 2014/0004617 A1
(43) Pub. Date: Jan. 2, 2014

(54) Radiation Generator Including Sensor To Detect Undesirable Molecules And Associated Methods

(71) Applicant: Luke Perkins, Plainsboro, NJ (US)

(72) Inventor: Luke Perkins, Plainsboro, NJ (US)

(21) Appl. No.: 13/538,741

(22) Filed: Jun. 29, 2012

(51) Int. Cl. G01N 27/00; G01N 31/00; B82Y 15/00

(52) U.S. Cl. 436/149; 422/83; 422/98; 977/742

(57) ABSTRACT

An electronic radiation generator includes a housing, a high voltage power supply, with—dielectric gas molecules inside the housing, at least some of the gas molecules to degrade into constituent components during operation of the particle generator. There is a metal-oxide-based sensor inside the housing to indicate presence of the constituent components. The sensor may indicate the presence of the constituent components by detecting corrosive molecules formed by a reaction between the constituent components, residual water vapor and electrical corona.

### FIELD OF THE DISCLOSURE

This disclosure related to sealed radiation generators, and, more particularly, to methods of monitoring the health or maintenance status of components of sealed radiation generators. Thus, the disclosure relates to prognostic health monitoring for the components of sealed radiation generators.

### BACKGROUND

Radiation generators, such as pulsed neutron generators (PNG), are commonly used in well logging tools to characterize a formation having a borehole into which the well logging tool is inserted. To produce neutrons, a neutron generator relies on the fusion of deuterium and tritium ions at high energies, which involves high voltages (on the order of 100 kV or more) in confined spaced. As such, the dominant neutron generator failure modes in the oilfield industry are electrical in nature.

Although a variety of common electrical causes for neutron generator failure are known, current maintenance protocols involve replacing certain components after a scheduled number of hours of operation. This can be inefficient in that some components are replaced while they are in satisfactory working order. Indeed, this situation is common, as maintenance intervals are often conservatively set such that failure is not expected to occur within those intervals. This increases operating costs of the tool since components are being purchased, and time is spent replacing the components, perhaps more often than may be useful with that given tool.

On the other hand, this can also be inefficient in that some components may not be replaced in time, and the tool may fail while being used to log the borehole. Tool failure while the tool is in the borehole results in the tool being removed from the borehole, repaired, and then reinserted. This increases the length of time used and cost to log the formation.

This situation leads to a desire to know the operational condition of components in the neutron generator. While components can be removed, inspected, tested, then reinstalled if found to have a useful operating life left, this process is time and cost consuming. Thus, it would be very helpful if there was a way to know the operational condition of components in the neutron generator without disassembling the neutron generator, and perhaps even while the neutron generator is running.

### SUMMARY OF THE DISCLOSURE

To address the foregoing issues, the present disclosure includes a radiation generator that may have a housing with gas molecules inside the housing. At least some of the gas molecules may decompose by separating into constituent components or by-products during operation of the radiation generator. There may be a sensor inside the housing to indicate presence of the constituent components.

In some applications, the present disclosure may include a radiation generator with a housing, and corrosive molecules in the housing. A sensor may be inside the housing to detect the corrosive molecules.

A method aspect is directed to a method of operating a radiation generator. The method may include disposing desired gas molecules in a housing, and operating the radiation generator such that at least some of the desired gas molecules decompose into constituent components. The method may also include detecting the constituent components using a sensor inside the particle housing.

This summary has been provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

FIG. 1 is a schematic cutaway view of a radiation generator showing a portion thereof sectioned along a longitudinal axis thereof, in accordance with the present disclosure.

FIG. 2 is a schematic cutaway view of a radiation generator showing a portion thereof sectioned across a longitudinal axis thereof, in accordance with the present disclosure.

FIG. 3A is a schematic cutaway view of a radiation generator showing a portion thereof sectioned along a longitudinal access thereof, the radiation generator including a removable plug to allow quick removal and replacement of the sensor, and in this view showing the removable plug and sensor installed in the radiation generator.

FIG. 3B is a schematic cutaway view of a radiation generator showing a portion thereof sectioned along a longitudinal access thereof, the radiation generator including a removable plug to allow quick removal and replacement of the sensor, and in this view showing the removable plug and sensor removed from the radiation generator.

FIG. 4A is a schematic cutaway view of a radiation generator showing a portion thereof sectioned along a longitudinal access thereof, the radiation generator including a slidable member to allow exposure of the sensor to either the gas in the radiation generator or to the external environment, and in this view showing the slidable member exposing the sensor to the gas in the radiation generator.

FIG. 4B is a schematic cutaway view of a radiation generator showing a portion thereof sectioned along a longitudinal access thereof, the radiation generator including a slidable member to allow exposure of the sensor to either the gas in the radiation generator or to the external environment, and in this view showing the slidable member exposing the sensor to the external environment.

FIG. 5 is a schematic cutaway view of a radiation generator showing a portion thereof sectioned along a longitudinal access thereof, the sensor thereof being disposed in a sensor housing with valves to selectively expose the sensor to either the gas in the radiation generator or to the external environment.

FIG. 6 is a schematic cutaway view of a radiation generator showing a portion thereof sectioned along a longitudinal access thereof, the multiple sensors thereof being disposed in separate sensor housings with valves such that each sensor housing can selectively expose the sensor contained therein to the gas in the radiation generator.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout, and elements separated in number by century (e.g. elements 100, 200, and 300) represent similar elements in other embodiments.

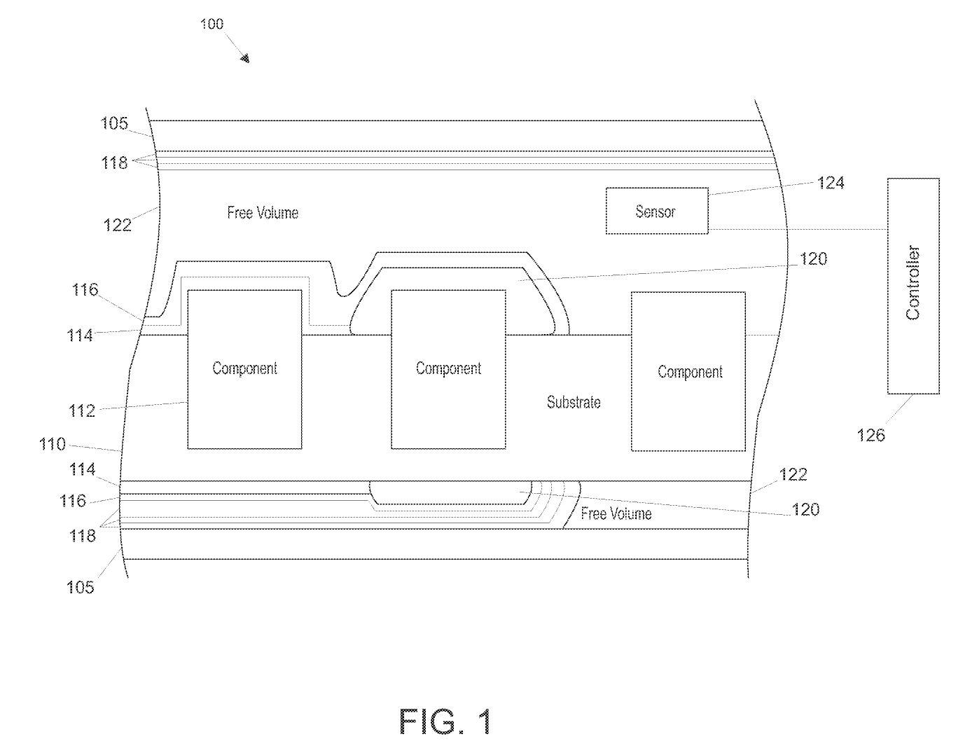

Referring initially to FIG. 1, a radiation generator 100 is now described. The radiation generator 100 includes a pressure housing 105 containing a high voltage power supply (not shown), a radiation tube (not shown), and some electrical insulation. Bulkheads (not shown) at each end of the housing 105 provide hermetic sealing. When appropriately energized by a power supply, the high voltage multiplier circuit (a.k.a., ladder) provides a series of increasing or decreasing potentials for use in the radiation-generating tube to create an electromagnetic field that accelerates ionized reactant particles, such as subatomic particles, toward a target. When the reactant particles strike the target, radiation and/or other particles are generated. Thus, it should be understood that by varying the potentials generated by the ladder, the target, and the choice of reactant particles accelerated toward the target, different kinds of radiation may be generated. In some application, the radiation generator 100 may accelerate ions toward a target so as to generate neutrons, for example, and thus may be a neutron generator. In other applications, the particle generator 100 may accelerate electrons toward a target so as to generate x-ray photons. Therefore, this disclosure should be construed as being applicable toward any sort of particle generator.

The voltages generated by the high voltage power supply may be on the order of hundreds of kilovolts; this can result in high electrical stresses in the confines of a borehole-size tool. Thus, the likelihood for corona discharges or for arcing between, both of which can alter the electric field in the radiation-generating tube as damage the radiation tube and the components of the high voltage power supply, is high. Consequently, the components of the high voltage power supply and neutron-generating tube may be shielded with dielectric layers. Indeed, the inside surface of the housing 105 itself may be likewise have dielectric layers (a.k.a., conformal coatings, pottings, encapsulants, sleeves) thereon, and an insulating gas may fill the free volume between the high voltage power supply and the housing. This arrangement will now be explained in detail.

As perhaps best shown in FIG. 1, the housing 105 carries a substrate 110 (also called a backbone) upon and within which the components 112 of the high voltage power supply are carried. The components 112 may be any suitable electrical components, such as resistors, capacitors, and diodes. Some components 112 may have an encapsulating dielectric layer 120 (also referring to as potting) formed thereon. This encapsulating dielectric layer 120 may be constructed from Sylgard, RTVs or Konform, for example, but may also be constructed from other suitable materials. Other components 112 may instead have a conformal coating layer 114 thereon, which may be constructed from a ceramic, such as Al₂O₃ or AlN. Heat shrink tubing 116 may be formed around the encapsulating dielectric layer 120 and/or the conformal coating layer 114. The heat shrink tubing 116 may be constructed from a fluoropolymer such as Fluorinated Ethylene Propylene (known as FEP), for example, but may also be constructed from other suitable materials. In addition, a series of nested sleeves 118, constructed from a fluoropolymer such as perfluoroalkoxy (known as PFA) may line the inside surface of the housing 105.

There is a free volume 122 between the components, the dielectric layers on the components 112 and the dielectric layers on the inside surface of the housing 105. This free volume 112 is filled with an insulating gas to provide insulation for those components without dielectric coatings, sleeves, or pottings. The dielectric gas may be SF₆, which is a particularly good insulator. Indeed, SF₆ is an electronegative molecule, which favors the quenching of electron avalanches. In addition, SF₆ has a high mass and this results in a low mobility, therefore, SF₆ does not readily accelerate to precipitate secondary avalanches and/or corona emissions from electrodes. Other dielectric gases such as C2H2F4, CF4, C4F8, as will be understood by those of skill in the art.

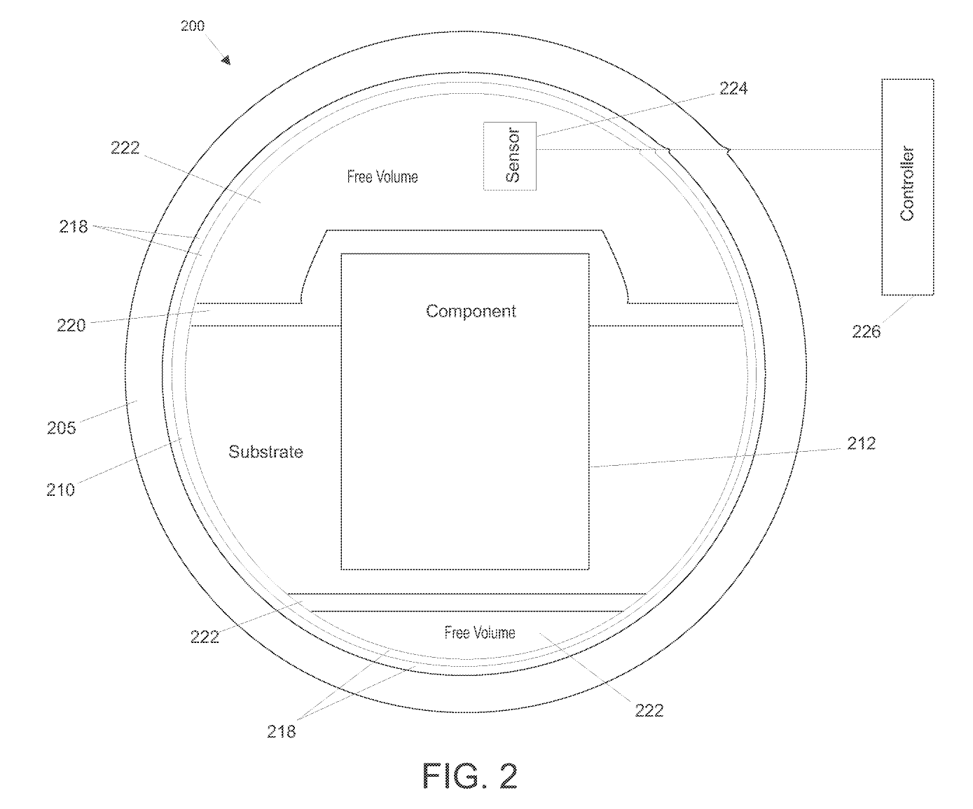

It should be appreciated that this variety of dielectric layers need not be formed in the same order as described and shown in FIG. 1. Indeed, the layers may be formed around a given component 112 in a different order, layers not shown as being stacked on each other may be stacked so, and some layers shown may not be present. Indeed, some components 112 may not have any coatings or layers thereon. For example, in the radiation generator 200 shown in FIG. 2, there are two nested sleeved 218 as opposed to three nested sleeves, and there is an encapsulating dielectric layer 220 on the component 212 but not heat shrink tubing. This radiation generator 200 was shown to illustrate the variety of dielectric configurations available, and the other components thereof not specifically described are similar to those of the particle generator 100 as shown in FIG. 1.

Referring again to FIG. 1, since the radiation generator 100 has an elongated shape, with a variety of components and layers of insulation inside, it has a large surface to volume ratio. The relatively large surface to volume ratio of the radiation generator 100 makes it difficult to thoroughly remove gasses present in the free volume 122, as the conductance therein is poor and there may be large trapped surfaces. Therefore, unfortunately, during assembly of the sealed radiation generator 100, some undesirable atmospheric gases, such as water vapor, may remain (from assembly) in the free volume 112 together with the insulating gas. The presence of this undesirable gas can ultimately lead to component failure, as will be explained below.

The presence of electrical corona is difficult to avoid when working such confined spaced as sealed radiation generators for the oilfield, with high potentials such as those in the high voltage power supply that generate high electric fields, and with components 112 having sharp, convex radii. In the presence of electrical corona, the SF₆ gas molecules begin to break into their constituent components or combinations thereof, sulfur and fluorine. If water vapor (H₂O) is present, the sulfur and fluorine molecules may combine with the hydrogen and/or oxygen atoms and produce undesirable molecules, such as the corrosive molecules H₂S, HF, and SO₂. These corrosive molecules may start to destroy the dielectric coatings, as well as any component not protected by a sleeve, potting, or coating, leaving the components 112 vulnerable to corona discharges and arcing. In addition, these corrosive molecules may be electrically conductive, and their presence thus may alter the electric field generated in the radiation tube even before failure of the dielectric coatings.

Maintenance for prior radiation generators includes, at a specified service interval, opening the bulkheads, removing the gas therein, changing faulty components, and refilling the free volumes 122 with fresh insulating gas. This is undesirable, however, in that the service intervals are cautiously set such that the gas is replaced before failure of the dielectric coatings and thus the components 112 is expected. This may result in the gas being replaced before an appreciable amount of the insulating gas has broken down into its constituent components and formed undesirable molecules or byproducts, thus causing unneeded downtime and maintenance costs. In addition, if this maintenance is performed in the field, the potential for contamination is greater, so avoiding the unnecessary changing of the gas in the field would be particularly useful. Alternatively, these service intervals may result in the gas not being replaced soon enough such that an appreciable amount of the undesirable molecules have formed, the consequence of which may be the replacement of components 112 or dielectric layers, and thus causing excess downtime and maintenance costs.

To address this situation, the radiation generator 100 of the present disclosure includes a sensor 124 carried by the housing 105 to be exposed to/sample the free volumes 122. It should be understood that the sensor 124 may also be carried by a variety of other components, such as the bulkheads. This sensor 124 indicates the presence of the constituent components of the insulating gas, and thus the breakdown of the insulating gas, by detecting the undesirable molecules. A controller 126, external to the particle generator 100, determines the level of the undesirable molecules based upon the indications of the sensor 124. It should also be appreciated that the sensor 124 may be configured to detect degradation of the conformal coating layer 114, heat shrink tubing 116, series of nested sleeves 118, or encapsulating dielectric layer 120. By this, it is meant that the sensor 124 provides information from which the controller 126 can infer that the conformal coating layer 114, heat shrink tubing 116, series of nested sleeves 118, or encapsulating dielectric layer 120 have suffered from degradation.

The sensor 124 may be a solid-state mixed metal oxide semiconductor. The sensor 124 may comprise two or more thin-films, a temperature sensitive heater film, and a hydrogen sulfide, for example, sensor film. The thin-films are deposited on a silicon microchip. The heater film elevates the operating temperature of the sensor film to a level where good (chemical) sensitivity is achieved. The sensor may be constructed from platinum or palladium, for example, or may be constructed from a tin oxide base with other metal oxide catalyst additives. Suitable sensors are known to those of skill in the art, and thus the selection thereof need not be described in detail.

The oxidation state of the material from which the sensor 124 is constructed may change based upon contact with the undesirable molecules. This change in oxidation state changes the electrical resistance of the sensor 124. Since the resistance of the sensor 124 may change with the temperature thereof in addition to the oxidation state thereof, the sensor 124 may be ohmically heated such that it maintains a generally constant temperature, to help provide consistent and accurate readings and results, as well as to help maintain a constant rate of chemical reaction. When the controller 126 reads that the resistance of the sensor 124 has changed, it can then determine that the level of undesirable molecules in the free volumes 122 has changed. In some applications, the controller 126 can even determine a ratio of the molecules of insulating gas to the undesirable molecules in the free volumes 112, for example. The controller can monitor the resistance of the sensor 124 over time, and can determine a maintenance indication based upon the determined level of undesirable molecules. The maintenance indication may be that it would be beneficial to the longevity of the dielectric layers and components 112 to change the gas in the radiation generator 100.

The maintenance indication may determined by the controller 116 in a variety of ways. For example, a threshold level of the undesirable molecules may be set, and once that threshold is exceeded, the maintenance indication may be that the gas should be serviced. Alternatively, a baseline reading may be taken prior to operation of the radiation generator 100, and when the sensor 124 indicates that this reading has increased by a threshold amount relative to the baseline, the maintenance indication may be that the gas should be serviced.

Different sensors 124 may be more or less sensitive to particular molecules, as will be appreciated by those of skill in the art. Thus, there may be an application with multiple sensors 124, each sensor configured to measure the level of a different molecule. In addition, it is noted that different molecules have different masses, and as such, will segregate according to their masses. Therefore, the location of the sensor 124 in the housing 105 can be selected so as to sense either high or low (vapor) density gases. In some cases, the housing 105 may even be manually flipped so as to have the sensor 124 read either high or low density gases.

As illustrated in FIG. 1, the sensor 124 is positioned in, and thus exposed to, the free volumes 122 of the radiation generator. The sensor 124 is shown as being mounted to an interior surface of the housing 105, but it should be appreciated that a variety of mounting options are available. During slickline or wireline operations, which are relative short in duration (<15 h), the radiation generator 100 may be configured such that the sensor 124 remains in the free volumes 122 during operation thus providing a live reading during operation. Due to the longer job duration and vibrational stresses inherent in measuring while drilling or logging while drilling operations, the radiation generator 100 may be configured such that the sensor 124 is easily insertable and removable, so that the sensor 124 may be inserted after the job has been performed (back at the shop), to record a post job concentration to compare with the pre-job concentration. Such a configuration may also be used in a slickline or wireline version of the radiation generator 100 to facilitate maintenance of the sensor 124, as will be described below.

Since the oxidation state of the sensor 124 changes over time with exposure to the undesirable molecules, at some point, the oxidation state will be such that the sensor 124 no longer gives accurate and/or repeatable results. Therefore, periodic maintenance may be performed on the sensor 124. This maintenance may include removing the sensor 124 from the radiation generator 100 and exposing it to oxygen such that it returns to its baseline oxidation state, and may also include performing a calibration of the sensor. Alternatively, the maintenance may include injecting oxygen into the housing 105, for example 3%-7% by volume.

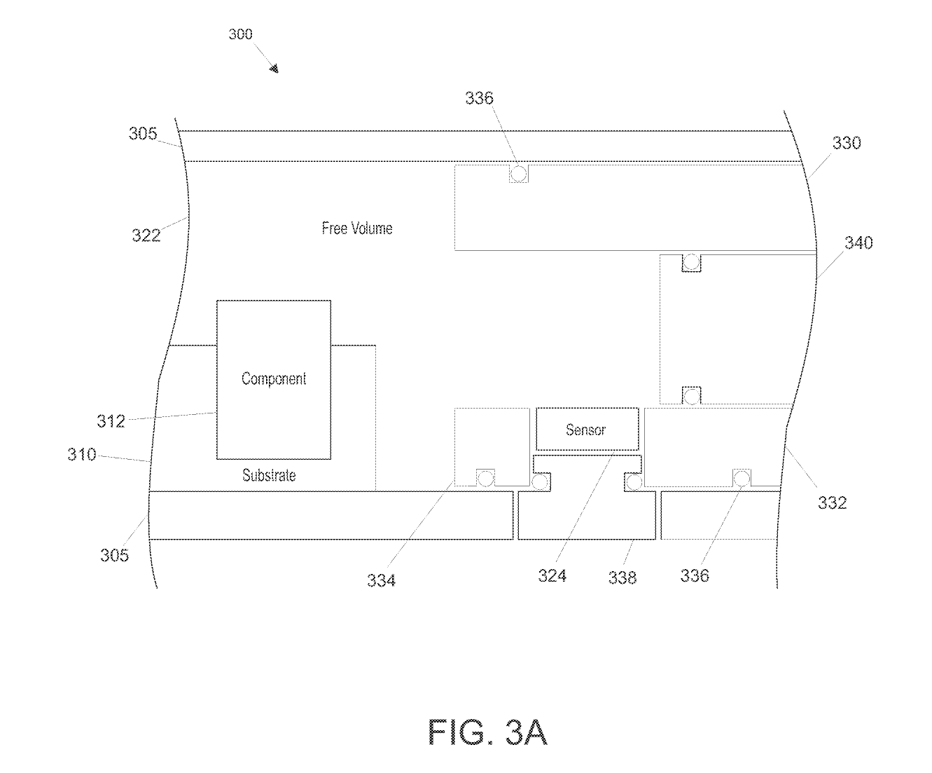

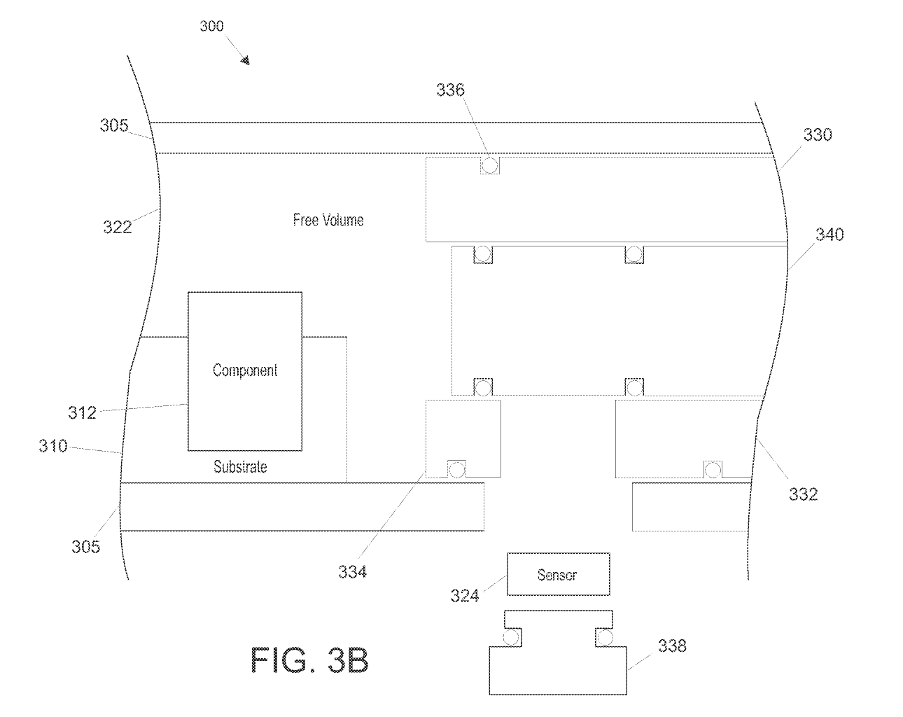

A configuration of the radiation generator 300 is shown in FIGS. 3A-3B that facilitates easy maintenance. Here, the housing 305 has an opening formed therein, and has a removable plug 338 positioned in the opening to seal the housing. The housing 305 carries blocks 330, 332, 324. Sealing rings 336 are fitted within the dielectric blocks 330, 332, 324. The blocks may be suitable parts of mechanisms inside the housing 305.

A movable sealing member 340 is disposed within the housing between the blocks 330, 332, 324, and is configured to extend such that it seals against the hole in the housing 305 (as shown in FIG. 3A) so as to allow removal of the removable plug 338, and thus the sensor 324, without venting the gas in the housing to the atmosphere. The movable sealing member 340 can also be retracted such that it allows exposure of the sensor 324 to the gas in the housing 305 (as shown in FIG. 3B).

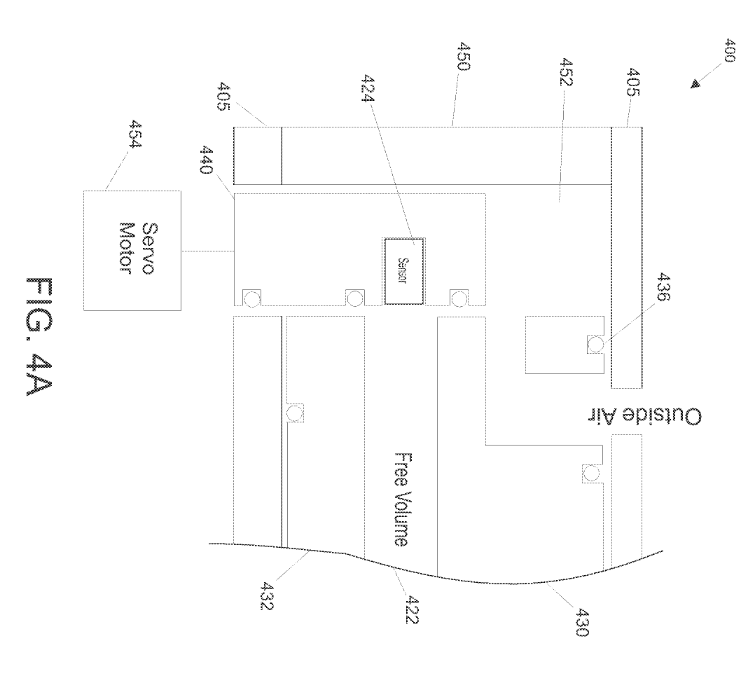

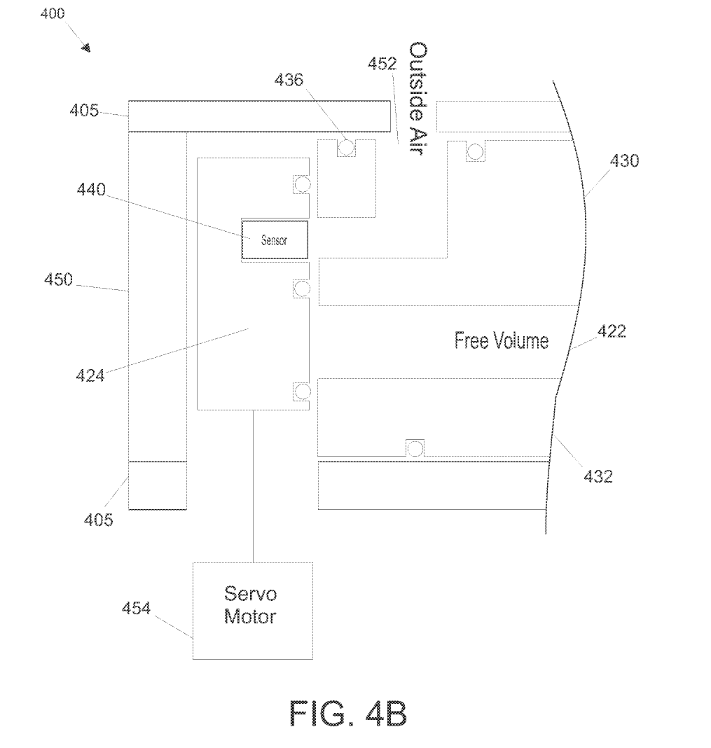

Another configuration of the radiation generator 400 is shown in FIGS. 4A-4B that facilitates exposure of the sensor 424 to outside air and thus oxygen, so as to return the sensor to its baseline oxidation state without the sensor being removed from the housing 405. In this view, the bulkhead 450 of the generator 400 which caps the housing 405 is shown. Dielectric members 430, 432 are disposed within the housing 405.

The housing 405 has an opening therein. In addition, a slidable member 440 carrying the sensor 424 is disposed in the housing 405, and is being movable such that the sensor can be selectively exposed to the constituent components of the gas molecules (shown in FIG. 4A), and to an environment external to the housing via the opening in the housing (shown in FIG. 4B). A servo motor 454 is coupled to the slidable member 440 to move the slidable member between the position where the sensor 424 is exposed to the gas inside the housing 405 or to outside air. The servo motor can be coupled to a controller which may activate it. This may be the same controller that reads the sensor 424 in some applications.

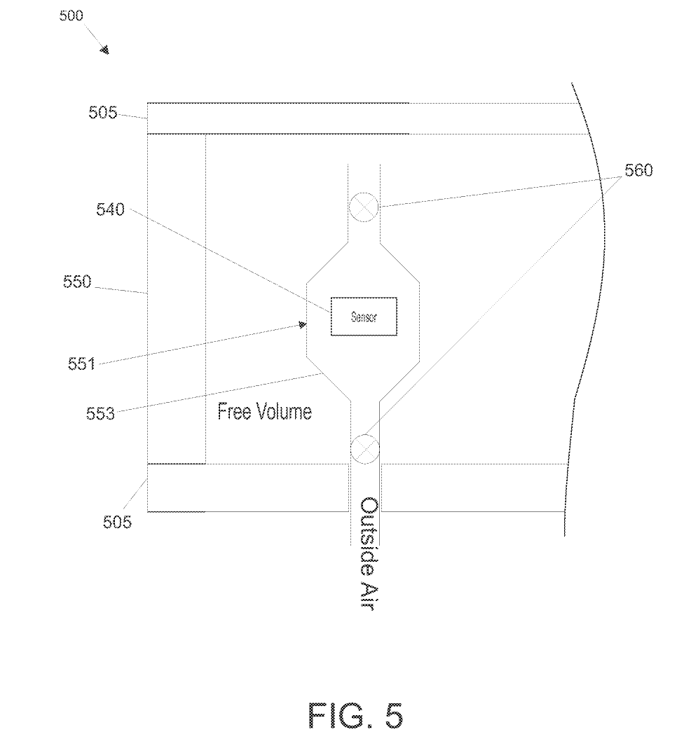

In yet another configuration of the radiation generator 500 shown in FIG. 5, the exposure of the sensor 524 to outside air is also facilitated, but in a different fashion. Here, the housing 505 also has an opening therein. A sensor assembly 551 is positioned within the housing 505, and has a portion thereof extending out of the opening in the housing. The sensor assembly 551 comprises a sensor housing 553 shaped such that it defines an internal free volume. Valves 560 are positioned in the sensor housing 553 and seal the internal free volume from both the free volume of the housing 505 (and thus the gas in the housing) and the outside air. The valves 560 can be selectively operated such that the sensor 524 can be exposed to the gas in the housing and not the outside air, so as to facilitate the sensor measuring the byproducts of the gas in the housing 505 breaking down into its constituent components. The valves can also be selectively operated such that the sensor 524 can be exposed to the outside air and not the gas in the housing, so as to allow the sensor to be exposed to oxygen and return to its baseline oxidation state. The valves 524 may be coupled to a controller which may activate them (not shown). This may be the same controller that reads the sensor 524 in some cases.

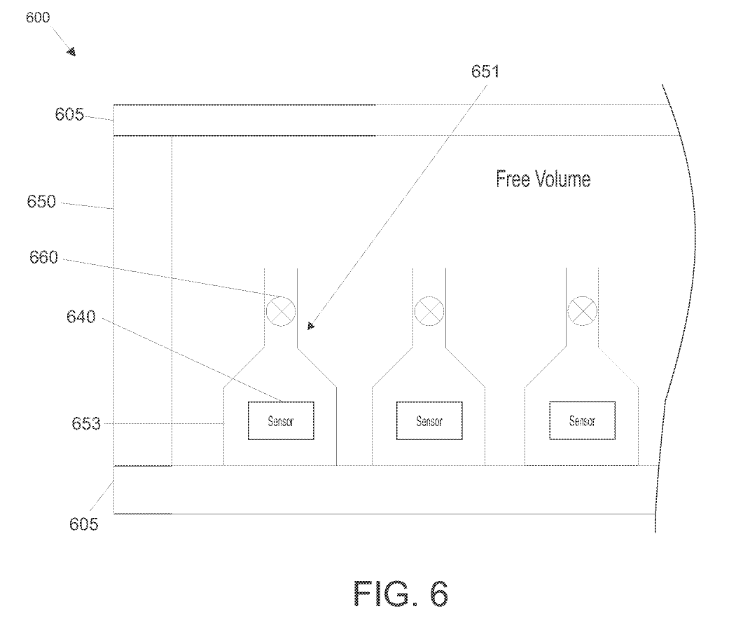

In still another configuration of the radiation generator 600 shown in FIG. 6, the exposure of the sensors 624 (there are three in this example) to the gas in the housing 605 can be regulated. Thus, a single sensor 624 may be used at a time, extending the maintenance intervals for the radiation generator 604.

Here, the sensor assemblies 651 include sensor housings 653 carrying the sensors 653 themselves. Valves 660 selectively seal the sensor housings 653 from the gas in the housing 605. As explained above, a single valve 660 may be opened at a time, such that the sensor 640 associated therewith is exposed to the gas in the housing 605 but the other sensors remain unused. When the sensor 640 that is exposed then reaches level of oxidation at which its quality degrades, the valve 660 may seal that sensor off and the valve of another housing 605 may be opened such that its sensor is then in use. The valves 660 may be coupled to a controller which may activate them (not shown), and this may be the same controller that reads the sensors 624 in some cases.

Although the foregoing has been described with reference to oilfield applications, it should be understood that the apparatuses described herein apply equally to any other devices in other industries that include high voltages in a sealed space with dielectric gas.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A radiation generator comprising:
a housing;
gas molecules inside the housing, at least some of the gas molecules to decompose into constituent components during operation of the radiation generator; and
a sensor inside the housing to indicate presence of the constituent components.

2. A radiation generator according to claim 1, further comprising water vapor inside the housing;
wherein at least some the constituent components combine with the water vapor to produce undesired molecules; and wherein the sensor indicates presence of the constituent components by detecting the undesired molecules.

3. A radiation generator according to claim 2, wherein the sensor indicates a presence of the undesired molecules by oxidizing based upon contact therewith.

4. A radiation generator according to claim 2, further comprising a controller coupled to the sensor to determine a level of the undesired molecules.

5. A radiation generator according to claim 2, wherein the controller is to determine a maintenance indication based upon the level of the undesired molecules.

6. A radiation generator according to claim 1, wherein at least some of the gas molecules comprise SF₆.

7. A radiation generator according to claim 1, wherein at least one of the undesired molecules comprises H₂S, HF, or SO₂.

8. A radiation generator according to claim 1, wherein an electrical resistance of the sensor changes based upon oxidizing of the sensor.

9. A radiation generator according to claim 1, wherein the sensor comprises a plurality of carbon nanotubes.

10. A radiation generator according to claim 1, wherein the sensor is ohmically heated.

11. A radiation generator according to claim 1, wherein the sensor comprises:
a sensor housing shaped such that it defines an internal free volume;
a sensor unit disposed in the internal free volume;
a valve in fluid communication with the internal free volume to selectively expose the internal free volume to the constituent components of the gas molecules such that the sensor unit is selectively exposed thereto.

12. A radiation generator according to claim 11, wherein the sensor further comprises an additional valve in fluid communication with an environment external to the radiation generator to selectively expose the internal free volume thereto such that the sensor unit is selectively exposed thereto.

13. A radiation generator according to claim 1, wherein the housing has an opening therein; and
further comprising a slidable member carrying the sensor and being movable such that the sensor can be selectively exposed to the constituent components of the gas molecules, and to an environment external to the housing via the opening.

14. A radiation generator comprising:
a housing;
corrosive molecules in the housing; and
a sensor inside the housing to detect the corrosive molecules.

15. A radiation generator according to claim 14, wherein an oxidation state of the sensor changes in a presence of the corrosive molecules to thereby alter output of the sensor to indicate the presence of the corrosive molecules.

16. A radiation generator according to claim 15, wherein the change in the oxidation state of the sensor changes an electrical resistance of the sensor such that the output of the sensor is altered.

17. A radiation generator according to claim 15, further comprising insulating gas molecules in the housing; and further comprising a controller coupled to the sensor to determine a ratio of the corrosive molecules to the insulating gas molecules.

18. A radiation generator according to claim 15, wherein the controller determines a maintenance indication based upon the ratio.

19. A radiation generator according to claim 15, further comprising insulating gas molecules in the housing; and further comprising a controller coupled to the sensor to determine a difference between a number of the corrosive molecules and a number of the insulating gas molecules.

20. A radiation generator according to claim 19, wherein the controller determines a maintenance indication based upon the difference.

21. A method of operating a radiation generator comprising:
disposing desired gas molecules in a housing;
operating the particle generator such that at least some of the desired gas molecules decompose into constituent components; and
detecting the constituent components using a sensor inside the housing.

22. The method of claim 21, wherein detecting the constituent components using the sensor comprises measuring a resistance of the sensor.

23. The method of claim 21, wherein undesired gas molecules are inadvertently disposed into the housing while the desired gas molecules are disposed in the housing; and wherein detecting the constituent components comprises using the sensor to detect corrosive molecules produced by a reaction between the constituent components and the undesired gas molecules.

24. The method of claim 23, further comprising determining a concentration of the corrosive molecules using a controller coupled to the sensor.

25. The method of claim 24, wherein accuracy of the sensor degrades based upon the concentration of the corrosive molecules; further comprising determining a maintenance indication based upon the degradation of the accuracy of the sensor; and further comprising exposing the sensor to oxygen to correct degradation of the accuracy thereof based upon the maintenance indication.
